(19) United States
(12) Patent Application Publication
(10) Pub. No.: US 2008/0190020 A1
(43) Pub. Date: Aug. 14, 2008

(54) Plant Watering System

(75) Inventor: Roger K. Todd, Chester (GB)

Correspondence Address: QUARLES & BRADY LLP, ONE SOUTH CHURCH AVENUE, SUITE 1700, TUCSON, AZ, 85701-1621, US

(73) Assignees: Roger K. Todd; TEKGENUITY LIMITED, Flintshire (GB)

(21) Appl. No.: 11/916,949

(22) PCT Filed: Jun. 8, 2006
(86) PCT No.: PCT/GB2006/002085

§ 371 Date: Apr. 11, 2008

(30) Foreign Application Priority Data
Jun. 8, 2005 (GB) 0511656.1
Jun. 8, 2006 (GB) PCT/GB2006/002085

(51) Int. Cl. A01G 25/16; A01G 27/00

(52) U.S. Cl. 47/48.5

(57) ABSTRACT

A plant watering system comprising a sensor (20) buried in the soil (32) in the root region of a plant (40), the sensor (20) passing a low voltage current through the soil (32) to measure the moisture content of the soil (32) and with the sensor (20) being switched on and off in a pulse like manner. The detected moisture level is processed by the system and water supplied to the plant when said moisture level is below a predetermined moisture level for that particular plant or group of plants (40). The systems predetermined moisture level may be adjusted to account for different plants within the system and to stimulate different growth cycles of the plant. The sensor (20) may also determine when said predetermined moisture has been reached and then terminate said supply. The electric current stimulates plant growth and the intermittent operation of the sensor helps prevent corrosion of the sensor and reduces power consumption. The sensor (20) may comprise a pair of spaced of electrodes and the moisture reading may be taken once the sensor has been fully energised.

The present invention relates to a plant watering system, and in particular, but not exclusively to a watering system suitable for automatically watering container plants.

Horticulturalists know that 80% of container plants die within 18 months of purchase. The main cause of plant death is that they are not given the correct amount of water. Usually plants are over watered, but getting the optimum amount of water to the plant is difficult even for expert irrigators. The visible signs of plant stress and damage often occur well after over or under watering and may be irreversible. This is why it is difficult to judge exactly how much water a plant should be given at any point in time depending on the plants life cycle and season.

Automatic watering systems are known which work on the gradual release of water, one such system is known from UK Patent Application GB 2 322 673 (Todd) which describes the use of a pump in a plant watering system. In this prior system a first probe located in the plant's soil determines the moisture content of the soil and is used to activate the pump to deliver water from a water reservoir to the top surface of the soil, when the moisture level drops below a fixed predetermined level. A second probe, located in the plant's drip tray detects the presence of water in the drip tray and is used to switch off the pump and stop the delivery of water, once water has been detected in the drip tray.

This system has the advantage that the plant is watered automatically and the only human intervention required is to keep the water reservoir topped up with water. This system however has the disadvantage that it makes no allowance for the actual requirements of the plant during its individual life cycle and/or season, this prior system only delivered water until a fixed level of soil wetness has been reached. Furthermore, the sensors are prone to corrosion with a resulting approximate life span of 6 months.

It is an object of the present invention to provide a plant watering system which overcomes or alleviates the above described drawbacks.

In accordance with a first aspect of the present invention there is provided a method of watering a plant comprising the steps of measuring the conductivity of a plant growing medium containing at least one plant, determining the moisture content of the medium from said measured conductivity, and supplying water to the plant if the determined moisture content is below a predetermined value, wherein said predetermined value is based on plant type and the step of measuring the conductivity is conducted using at least one sensor buried in the soil in the root mass of the plant, which at least one sensor is intermittently powered.

The predetermined value may be based on plant growing medium type and may be adjustable which may be based on the requirement of a plant and/or plant type.

The method may include the step of energising the electrodes for a period of time before determining said moisture content. The growing medium between the electrodes acts like a capacitor, therefore there is a finite delay in applying the potential and the charging of the soil to that potential. By delaying the reading until the growing medium has been fully charged enables a more accurate reading to be taken. In a preferred embodiment said period of time is at least 15 seconds.

The method may include the step of energizing the sensor in a pulse like manner. This enables the sensor to be de-energised after a reading is taken and for the growing medium to discharge. The net effect of this discharge is to take the positive electrode slightly negative and hence electrode corrosion is reduced. In a preferred embodiment the space between pulses is sufficient to enable a full discharge of the charge built up within the growing medium. Furthermore by operating the sensors in a pulse like manner, means that the intermittent firing of the electrodes reduces the overall energy consumption of the system, when compared to a continuous operation.

The method may include the step of placing the sensor below the root ball of the plant. This has the advantage that as the plant grows the sensor becomes embedded in the root system and this leads to a much finer control and water conservation. Experiments have determined that when the sensor becomes embedded in the root system the water requirement tend to drop as the moisture levels are more closely controlled by the plant.

The method may comprise the step of stopping the supply of water once a desired level of moisture has been detected.

The method may comprise the step of supplying a predetermined fixed amount of water to the plant based on said detected moisture level and a predetermined requirement for a respective plant.

The method may comprise the step of selecting a predetermined watering program to supply a predetermined fixed amount of water to the plant based on said detected moisture level and said predetermined requirement for a respective plant.

The method may comprise the step of measuring the temperature of the soil and/or environment and providing heat to the plant and/or soil if the temperature drops below a predetermined value.

It is an object of the present invention to stimulate at least one of plant growth, flowering and fruiting.

In a further preferred embodiment there is provided a method of inducing plant growth comprising the steps of passing electromagnetic field through the soil or growth media of at least one plant to stimulate growth of said plant (s).

The method may comprise the step of passing said electromagnetic field in at least one of continuous manner and intermittent (pulsed) manner.

The method may comprise the step of adjusting said electromagnetic field to adapt it to stimulate at least one of induction of flowering, fruiting or growth of plant.

The method may comprise the step of adjusting said electromagnetic field to adapt it to the particular growth requirement of a specific plant type.

The method may comprise the step of adjusting said electromagnetic field to adapt growth stimulation to at least one of season, time of day, soil/growth media type, and soil/growth medium condition.

The electromagnetic field may be a low voltage electrical current. The electromagnetic field may comprise at least one of low voltage direct current and low voltage alternating current.

The method may comprise the step of measuring the condition of the soil. The method may include the step of measuring the condition of the soil and providing to said plant at least one of heat, water, plant nutrients and stimulation based on said detected condition. The step of measuring the condition of the soil may include the step of measuring at least one of moisture content of the soil, PH of the soil, and temperature of the soil and/or environment.

The method of inducing plant growth may include a method of watering a plant as described herein.

In accordance with a second aspect of the present invention there is provided a system for carrying out the method of watering a plant comprising a closed loop moisture control system comprising a water supply system for supplying water to the plant, a moisture sensor for measuring the level of moisture in the growing medium of the plant, and a control unit with means to switch the watering system off and/or on based on said detected moisture level and for energising the sensor.

The system may comprise a control unit which is adapted to energise the sensor in a pulse like manner.

The moisture sensor may comprise at least one pair of spaced apart electrodes and the sensor is energised by applying an adjustable preset voltage to the electrodes in order to measure the conductivity of the growing medium between the electrodes, the control unit heaving means to determine the level of moisture in the soil based on said measured conductivity.

The control unit may have means to set said predetermined voltage said predetermined voltage being a function of at least one of plant type, growing medium type and sensor type.

The electrodes may be spaced between 40 to 100 mm apart and may have a surface area of between 400 mm and 1000 mm and may have a length of 80 to 2000 mm each and may have a width of 2 to 4 mm each.

Preferably the electrodes may be made from a conductive material and not be prone to corrosion in a damp environment. Stainless steel, grade 304 or 316, is excellent for both soil moisture content measurement and water level sensing.

The control unit may be programmable with at least one program which enables a predetermined amount of water or water and nutrients to be delivered based on said detected moisture level.

The watering system may comprise a water tank with at least one soaker pipe leading therefrom, the soaker pipe being adapted to supply water to at least one plant. The water tank may incorporate a sensor for detecting the level of water therein, said sensor may be operated in a pulse like manner.

A pump may be provided to pump water from the tank to the soaker pipe, the pump being switched on and off by said means for switching the watering system on and/or off. The pump may operate by pumping water using thermal expansion and contraction of a quantity of gas trapped in a housing.

The watering system may be adapted to top water at least one plant.

The control unit may be operatively connected to a display unit, the display unit having means to indicate at least one of the following water in the water tank low/empty, water in the water tank full, pump is running, and detected moisture level.

A PH sensor may be provided to measure acidity of the soil.

In a preferred embodiment there is provided a plant growth stimulator comprising an electromagnetic field generator and means to supply said electromagnetic field to root region of at least one plant.

The electromagnetic field generator may be a low voltage electricity supply may be at least one of low voltage direct current and low voltage alternating current. The stimulator may comprise control means. The control means may have means to supply the electromagnetic field in at least one of an intermittent manner and continuous manner. The means to supply may be adjustable.

The control means may be programmable. The means to supply said electromagnetic field may be in the form of at least one pair of spaced apart electrodes with the field being supplied between the electrodes.

The means to supply said electromagnetic field to the roots of the plant may be in the form of or comprise a probe. The control means may have means to process telemetry provided by the probe. The control means may have means to adjust said electromagnetic field based on said telemetry. The probe may be adapted to sense at least one of soil moisture content, soil PH and soil temperature.

The stimulator may comprise an automatic watering system as described herein. The control system may have means to activate the automatic watering system based on said telemetry.

The stimulator may comprise a heater to heat the soil and/or growing media of a plant. The control system may have means to control the heater based on said telemetry.

By way of example only specific embodiments of the invention will now be described with reference to the accompanying drawings, in which:—

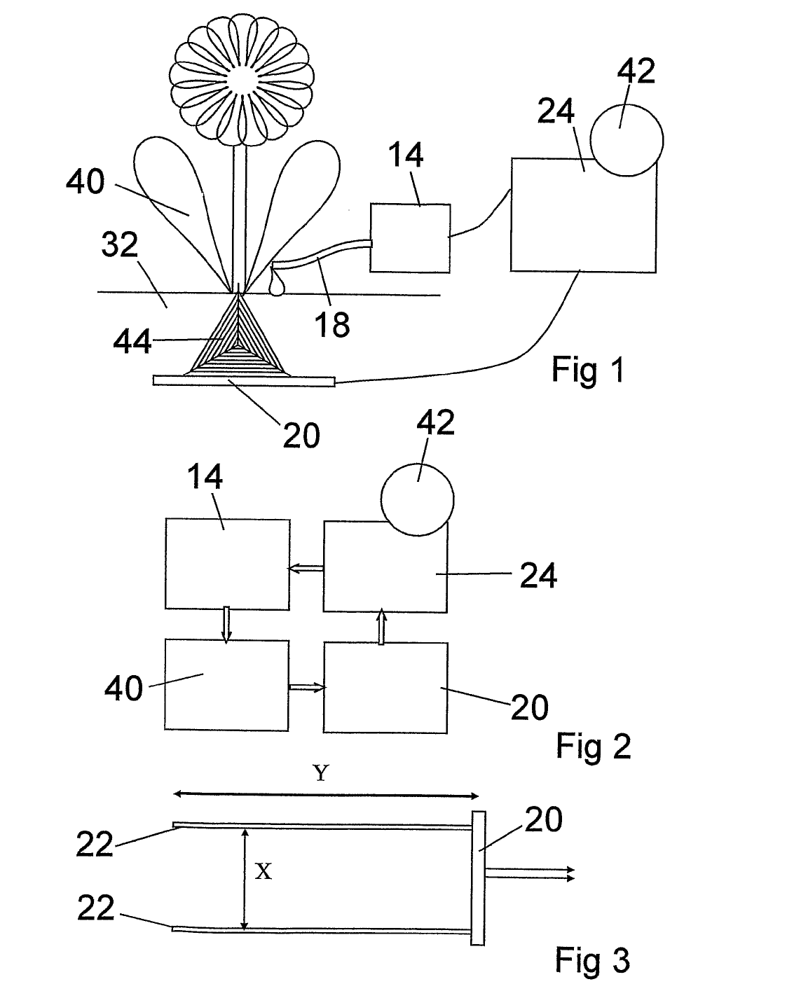

FIG. 1 is a schematic view of a basic plant watering system constructed in accordance with the present invention;

FIG. 2 is a diagrammatic representation of the system of FIG. 1;

FIG. 3 is a detail of the moisture sensor detector of FIG. 1;

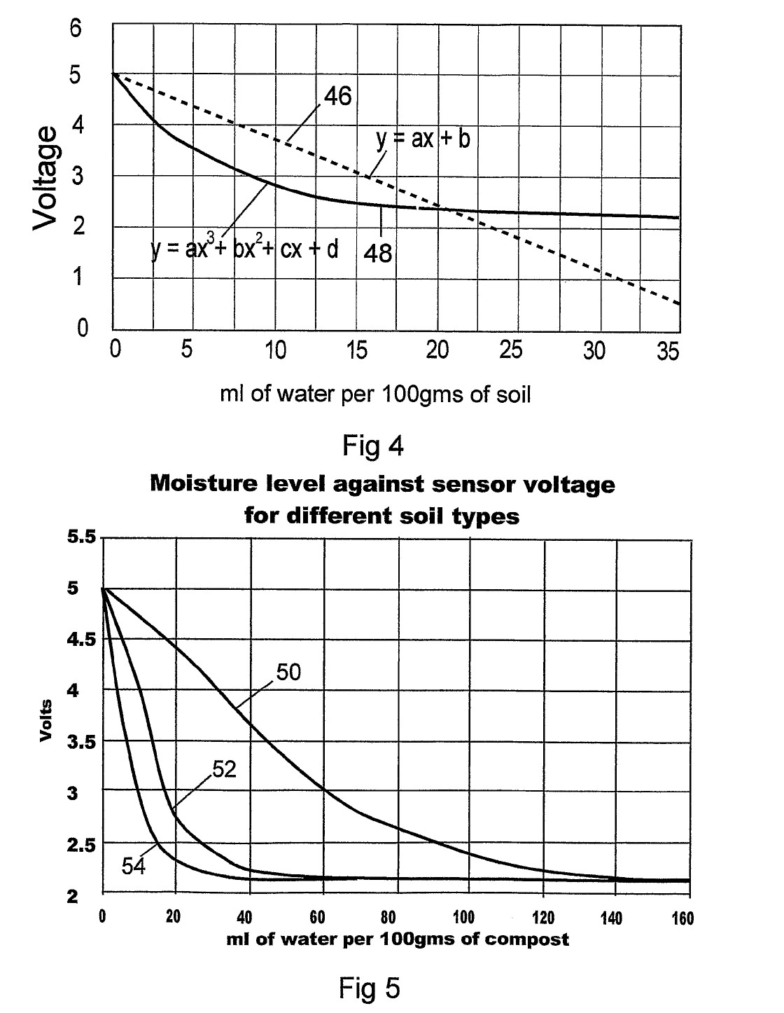

FIG. 4 is a graph showing the relationship between applied sensor voltage and water content of the growing medium;

FIG. 5 is a graph similar to that of FIG. 4 showing moisture level against sensor voltage for different soil types;

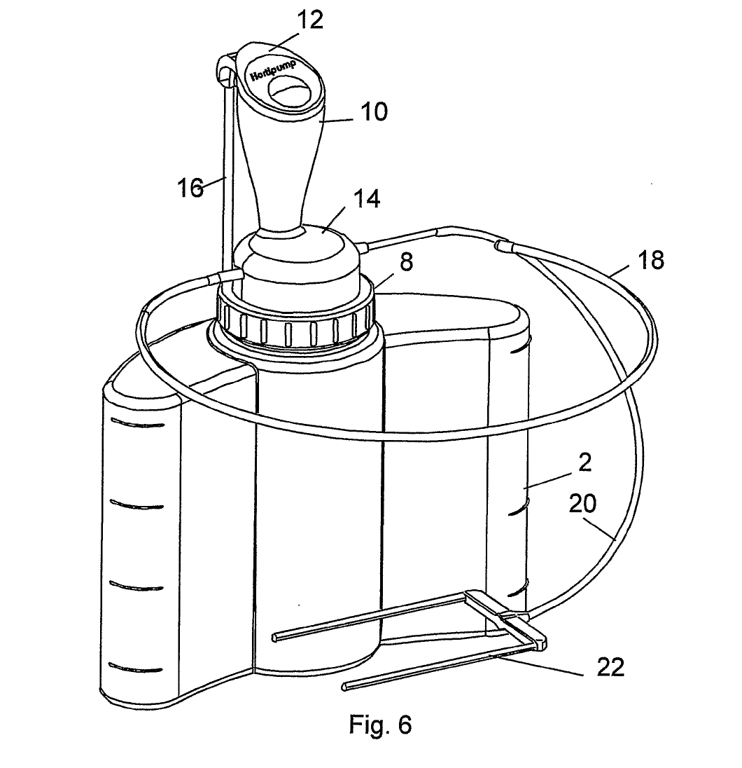

FIG. 6 is a perspective view of a first practical application of the plant watering system of the present invention;

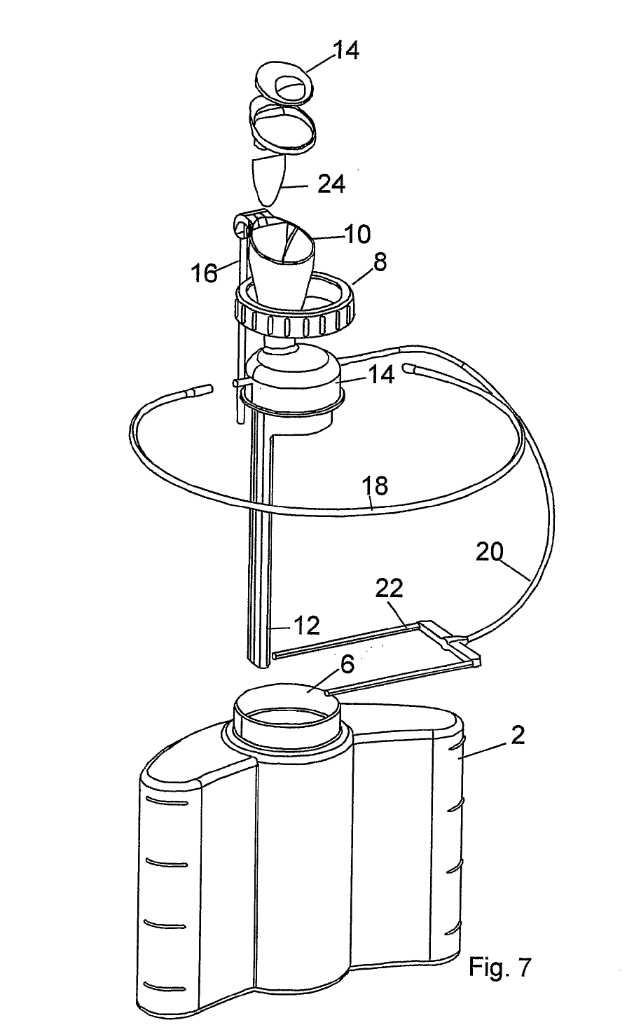

FIG. 7 is an exploded view of the watering system of FIG. 6;

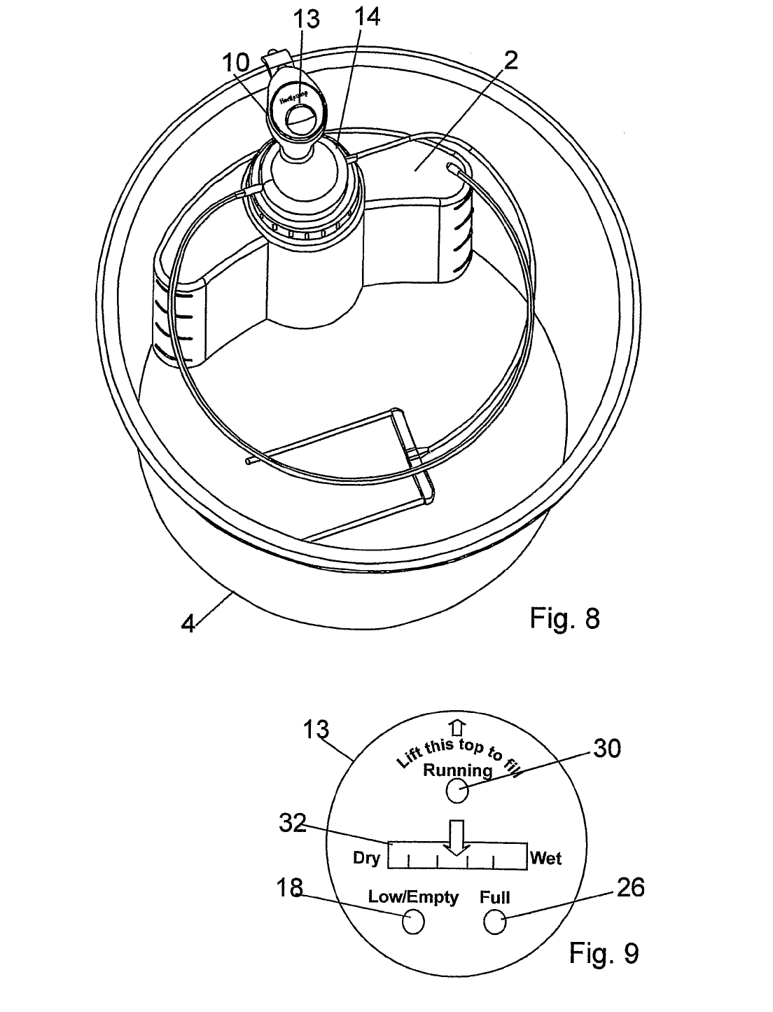

FIG. 8 is a plan view of the plant watering system of FIG. 6 shown installed in a plant container;

FIG. 9 is a plan view of the pivotable cap of the plant watering system of FIG. 6;

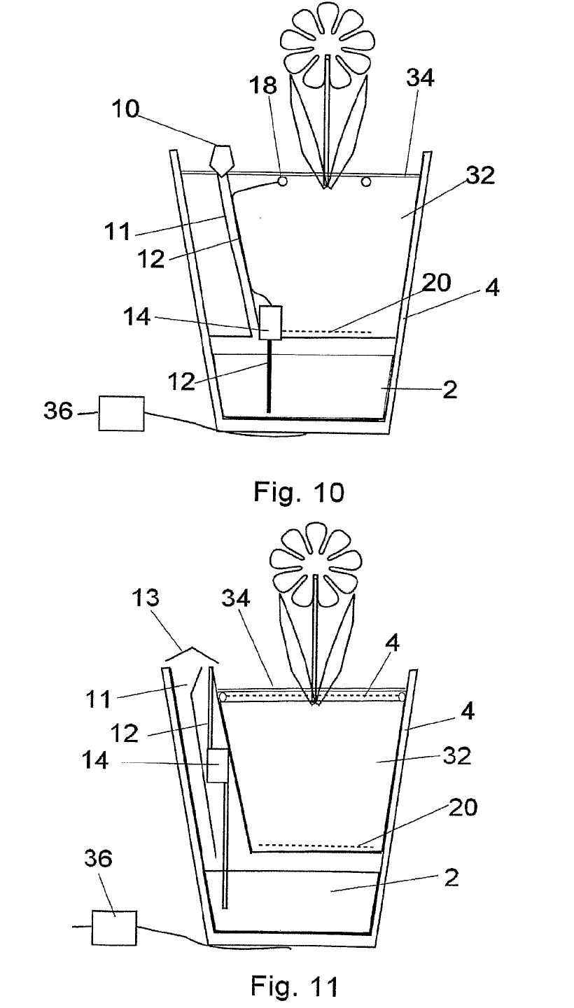

FIGS. 10 to 13 are each sectional views of further practical applications of the watering system of the present invention respectively, each of which is illustrated located in a container;

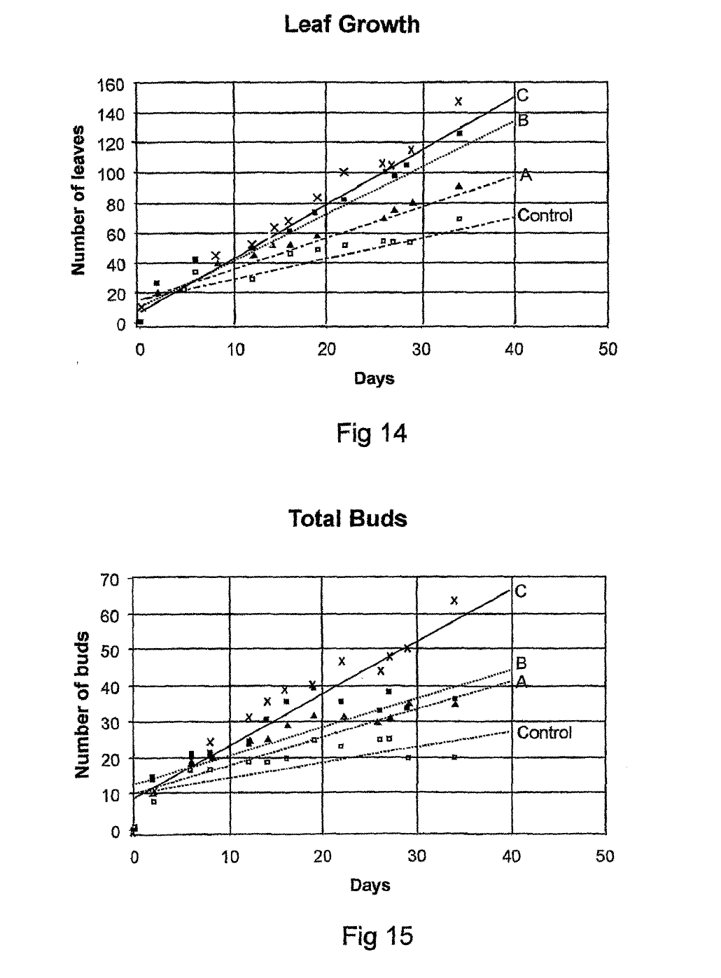

FIGS. 14 and 15 are graphs showing the results of a trial of plant growth stimulator constructed in accordance with the present invention.

There are many methods used to measure the moisture content of growing mediums and most are used as stand-alone devices. Methodologies include Dielectric constants, Tensiometric, Heat dissipation, Resistance and Neutron probes to name a few of the more common types. The main draw back of these sensors is they can be expensive to make, require complex electronics, are adversely affected by temperature and salinity and not designed to work with small volumes of growing medium or single plants. Some sensors types can be used to activate watering systems when a predetermined level of moisture is reached but no systems are designed to use the plant, itself, as part of the controlling system. This invention describes how a simple sensor is used in conjunction with a simple control system and a water source to provide a closed loop moisture control system that once started in operation integrates the plant into the system as part of the control system. The system has been used with great success in trials on a range of plant types and plant sizes with the largest being a two metre Mandarin Orange tree. Although initially used for single plants the system has been extended to cater for groups of similar plants with results similar to those for single plants.

As best illustrated in FIGS. 1 and 2 the basic plant watering system comprises the moisture detector sensor 20 which is energised at intervals by the control unit 24 to measure the moisture content of the growing medium. The control unit 24 compares the data from the sensor 20 with an adjustable preset value 42 that has been manually set. If the sensor 20 value indicates that the moisture content is below that set by the manual setting it instructs the water supply system 14 to slowly drip water through a soaker pipe 18 to the surface of the plant growing medium 32. This action continues until the sensor data and the manual setting are in coincidence.

When a new system is started the manual setting 42 is set to a value that is considered to be approximately correct for the plant type. The growing plant 40 takes up water through its root system 44 thus reducing the moisture level in the growing medium 32 and hence the sensor 20 will indicate the drop in moisture level to the control unit 24 when it is energised.

Experiments have shown that a plant 40 will initially take water, from the water supply system 14 in a number of sessions that can last for many hours with long period when no water is taken. During this period the conductivity of the growing medium 32 can be seen to fluctuate between dryer and wetter. After several weeks of operation the water demand has leveled out so that there are no long periods of water demand and no water demand. The conductivity of the growing medium 32 can be seen to fluctuate very little. The plant 40 has at this point taken over control of the system and is manipulating the closed loop system to its own demands. Experiments have shown that once this happens the growth of the plant 40 exceeds normal expectations. Indeed experiments with the described system against expert waterers have shown a distinct growth difference with the described system and produces growth some 20% or more beyond that achieved by the expert waterer. In addition savings in water usage of 15% to 50% have been recorded by using the described system.

The control unit 24 can be electromechanical or purely electronic and driven by a small micro computer. The water supply 14 can be provided by a slow acting pump or fed by gravity. The sensor construction and how it is used is described further herein under.

As best illustrated in FIG. 3 the sensor 20 consists of two spaced corrosion resistant metal strips or electrodes 22. Experimental work has shown that the length of the electrodes (Y) rather than their distant apart (X) is a critical feature. It could be assumed that if measurements were taken with a sensor (with a fixed voltage supply) that was able to have the electrodes gradually moved apart (Distance ‘X’ made larger) it would show higher readings when closer together compared with those wider apart. (i.e. the further apart the electrodes 22 the more soil between the electrodes and hence more resistance to current flow). This is not the case and experiments have shown that spacing of 10 mm to 100 mm have a reading variation of less than 2%.

It could also be assumed that if the electrodes were at a set distance apart and the applied voltage incremented, that the voltage readings would increase in a predictable manner. For example a value of 3 volts recorded across the sensor 20, with a supply voltage of 5 volts dc would imply a value of 6 volts at a supply voltage of 10 volts. Again this is not the case as the latter value is actually 4.25 volts dc. It can be shown that the voltage increase follows an equation of kx=y−π where x=voltage increment and y=the sensor voltage reading and k=a constant applicable to that particular growing medium 32. So the distant apart of the electrodes 22 is not critical but widths (X) below 20 mm to 40 mm are only measuring a small area of growing medium 32 and would only be applicable to use in small plant pots. As a rule of thumb the electrodes 22 should be spaced to cover at least 50% of the width of the plant root ball.

The length of the electrodes (Y) does affect the measurements made with the sensor 20. As the electrodes are made longer, more surface area is covered, and the lower the recorded voltages. The same applies to the width of each electrode. An optimum size for the electrode width is 2 mm to 4 mm. If smaller they become more fragile and larger they become more expensive and if too large it can affect the watering pattern. The electrodes length (Y) needs to be optimised for a system in two ways. One is the sensor applied voltage and the second the length of time the sensor voltage is applied. If the electrode length is too long it will not allow the charge built up on voltage application to discharge before the voltage is applied for the next cycle. This will result in accelerated corrosion of the positive electrode.

To enable a system to use the sensor 20 to supply information on the conductivity and hence the moisture content of the growing medium 32 it has to be energised by applying a known voltage to the sensor 20 through a current limiting resistor (not illustrated) located in the control unit 24. Upon the application of the energising voltage current passes through the growing medium 32 and depending on the conductivity of the growing medium 32 and the value of the current limiting resistor, voltage will be dropped across the resistor and the sensor 20. Although it could be expected that this action would happen very quickly it does, in fact, take time for a steady state to be reached. Typically 15 to 20 seconds has to elapse before the voltage becomes stable enough to give a true reading. The application of the exercitation voltage has characteristics similar to that of applying a voltage to a capacitor through a resistor and is thus very similar to an exponential curve. Only when the voltage has stabilised at around 20 seconds can a stable reading be taken. When the energising voltage is removed it also decays in a manner similar to a discharging capacitor and for it to reach a stable state can take 40 to 60 seconds. By utilising the described characteristics it means that the sensor 20 can be used to measure growing medium conductivity and hence its moisture content with sufficient accuracy to ensure that a closed loop control system comprising the sensor 20, a water delivery method 14 (pump, gravity of any other controllable methodology) and a controlling unit 24 that uses the sensor data to deliver water in a controlled manner to maintain a set moisture level.

Experimentation has shown that when the sensor is placed below the plant root ball 8 and the roots grow around the sensor 20 the plant 40 effectively takes over control of the system and can maintain the desired moisture level for optimum growth conditions. This has proved to be true even when the control unit 24 had a manual ‘moisture level setting’ 42 which enabled settings ranging from and to saturated and provided that the system was set either side of a mid position the plants 40 were able to control the system to meet their water requirements. This has enabled plants 40 that are difficult to grow and sensitive to their watering requirements to be grown with relative ease.

Some standard commercial systems declare that a short measurement period must be used otherwise the current from an electrically stimulated sensor will start an electrolysis process which invalidates sensor data. If the current through the sensor 20 is kept to very small values, micro amps, this can not happen. In addition many commercial systems declare that temperature and salinity are critical, however experiments have shown that temperature has little or no affect on sensor readings. Although salinity can alter the conductivity of water to have any noticeable affect on this sensor system it has to be at levels where plants are unable to grow.

Plant growth is slow and it can take many hours for conditions to change such that a plant starts to suffer stress due to lack of water. This means that monitoring of the growing medium moisture content does not have to be carried out continuously but can be carried out at intervals that could range from many minutes to several hours. In a practical system the monitoring would need to be carried out at least several times an hour but as the plant water usage is determined by temperature, humidity etc by measuring these environmental parameters it is possible to alter the frequency of sensor measurement activity to meet environmental conditions. For a control system that is run from batteries and/or solar power this will enable power to be conserved.

As best illustrated in FIGS. 4 and 5 the sensor 20 in the described system is designed to measure the conductivity of the soil in which it is placed. This is carried out by applying a known low voltage, say 5 volts dc, to the sensor 20 via a known value resistor say 10 K′Ω. As the growing medium 32 is made to go from completely dry to saturation (i.e. can not hold any more water) readings from the sensor will gradually drop from the supply voltage to a minimum level for voltage and for current from zero to a maximum level. It could be assumed that the voltage drop would follow a simple formulae such as y=ax+b, (46). This is not the case and experiment has shown that it actually follows a third order polynomial Y=ax³+bx²+cx+d (48) and the saturation level occurs around 40% of the applied voltage. The current also follows a third order polynomial.

It could also be assumed that different growing medium types would have very different profiles but this in not the case. Taking cases such as a soil based compost like John Innes (50) and a sphagnum peat based compost (52) the resulting polynomials show little difference but the amount of water held at saturation can be up to 500% greater for the peat when compared to the John Innes compost. In a similar manner the John Innes compost (31) can be shown to hold 100% more moisture that an alluvial clay 54. This shows that the sensor system can be used to determine the moisture content of any soil like plant growing medium. This also shows that provided the growing medium is known the system can be set to provide a set level of moisture content in that medium. It has also been shown that the system can be used with plant growing mediums other than soil or peat based mediums. For example Coya™—made from coconut husks—is similar to peat and can thus be included in the soil base mediums. Silica/chalk based mediums have similar characteristics to the soil based mediums but have a slightly higher saturation voltage, approximately 10% to 20%. Clay pebbles, a common hydroponics growing medium, can also be used by the system but the saturation voltage is much higher, approximately 40%.

Referring to FIGS. 6 to 8, a first practical application of the plant watering system, the system comprises a water tank 2 which in use is placed into a plant container 4. The water tank 2 has an inlet 6 sealable by a screw cap fitting 8. A filler port 10 extends through the screw cap 8 and opens into the inlet 6. The filler port 10 is selectably sealed by a pivotable cap 13. The water tank 2 is filled by pouring water therein through the filler port 10.

A feed pipe 12 extends from the base of the water tank to a pump 14. The pump 14 is connected via cabling 16 to a power supply (not illustrated). A soaker pipe 18 is connected at one end to the feed pipe via the pump 14. The soaker pipe 18 comprises a plurality of pores. A moisture detector sensor 20 having two electrodes 22 is connected to a control until 24. The control unit 24 and sensor 20 are powered by said power supply and the control unit 24 is operatively connection to the pump 14.

In use the watering system is located in a plant container with the water tank buried in the growing medium or soil 32 and with the filler port 10 protruding from the soil's surface. The soaker pipe 18 is placed on to the soils surface about the plant. To this end the soaker pipe 18 has a pivotable connection to the pump 14 enabling its easy placement. A layer of gravel or the like is placed over the soaker pipe 18 once in place to reduce water evaporation. The moisture detector sensor 20 is buried some 50 to 100 mm below the plant.

The water tank 4 is filled with water and the system activated. The control unit 24 has a sensor activation unit for activating the sensor 20 by providing a pulsing action to the sensor 20, in this embodiment the sensor 20 is provided with a 5 volt 15 second pulse every 60 seconds across its electrodes 22. During this pulse cycle the sensor 20 becomes active and measures the resistivity of the soil. The measured value is compared to a manually adjusted preset value to determine the moisture content of the soil. When the moisture content drops below a desired level the control unit 24 activates the pump 14 to pump water up from the water tank 2 via the feed pipe 12 to the soaker pipe 18, from which it drips onto the surface of the soil and then soaks down through the soil. When the sensor is active and detects a resistivity of the soil which equates to a desired moisture level, the control unit 24 deactivates the pump and prevents the further supply of water.

Additional sensors (not illustrated) are provided in the feed-pipe 12 of the water tank 2 to monitor the level of water therein and to provide signals to the control unit 24 when the water level in the tank is low/empty, full. One tank sensor is provided adjacent the bottom end of the feed-pipe to provide an indication of water low/empty, another tank sensor is provided adjacent the opposite end of the feed-pipe to provide an indication of tank full. The tank sensors are operated in a pulse like manner in that they are cyclically switched on and off. The pivotable cap 13, as best illustrated in FIG. 9, is provided with indication means controlled by the control unit 24 to provide an indication of when the water tank is full 26, when the water tank is low/empty 28, when the pump is running 30 and an indicator to show the detected moisture content of the soil 32.

In a further embodiment of watering system as shown in FIG. 10 the upright water tank 2 is modified to be provided as an insert which fits into the base of the container 4 with the feed pipe 12 extending up along the water inlet pipe 11 to the soaker pipe 18 which extends over the top surface of the soil 32 beneath a layer of gravel 34. The pump 14 is powered by a power unit 36 which is a 240 v ac to 9 v ac at 500 mA. It is to be understood that although the water tank has been described as an insert to the containers, the container and watering system could be an integral unit.

In a yet further embodiment as illustrated in FIG. 11 the watering system is in the form of an insert for a standard container and comprises a pot adapted to hold the soil and plant within the container so as to leave a space at the base of the container to form the water tank. As in previous embodiments a water inlet pipe 11 extends between the filler port 10 and the water tank 2, and a feed-pipe 12 extends between the water tank 2 and soaker pipe 12 and is operated by the pump 14.

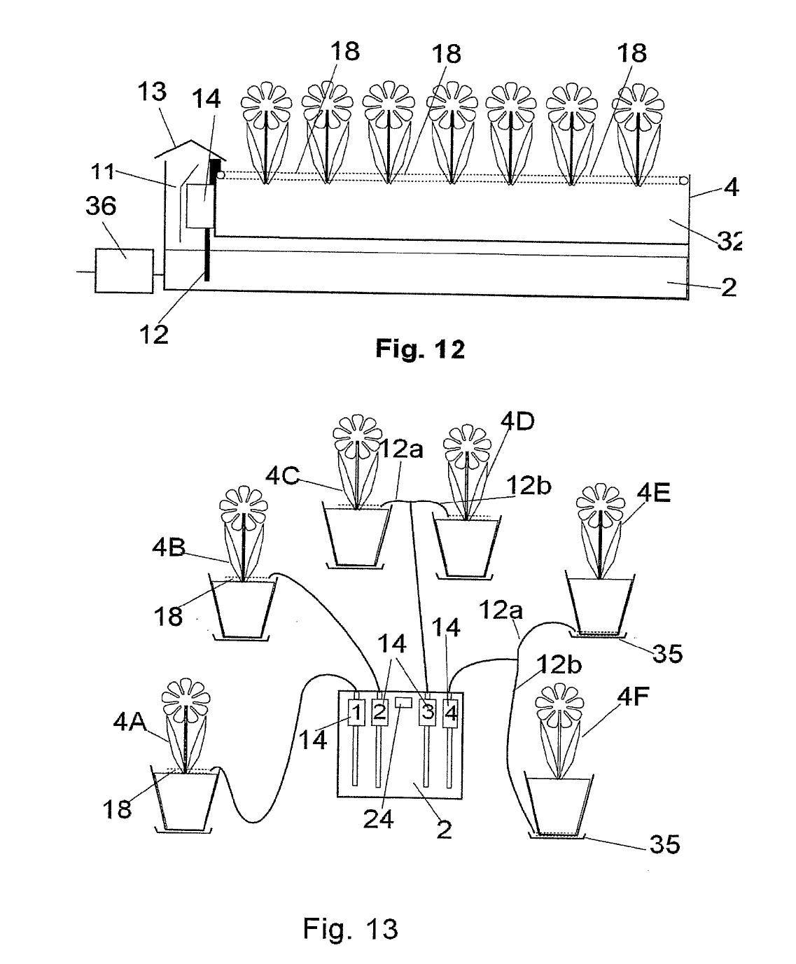

In a further embodiment of watering system, as illustrated in FIG. 12, the watering system is modified to automatically water a trough 4 containing a plurality of plants. In this instance the soaker-pipe 18 would extend the length of the trough to supply water to each plant.

In a further embodiment of plant watering system as illustrated in FIG. 13 the watering system is modified to supply water to incorporate a multipump system in which water is pumped from the water tank to a plurality of containers. A single pump 14(1), 14 (2) supplies water to top-water a respective descrete container 4A, 4B. Pump 14(3) supplies water to two containers 4C and 4D by providing a fork 12a 12b in the feed-pipe 12 to feed into a respective soaker pipe 18 on the surface of each container. Pump 4(4) also pumps water to two separate containers 4E, 4F, but in this instance the system is modified to feed water to the bottom of each plant container by filling the respective containers drip tray 35 with water.

The watering system in a further embodiment is further modified to provide a system which can be operated outdoors for example to automatically water container plants on patios etc. In order to avoid flooding of the plant, if there is heavy rain drainage holes are provided which drain into the water tank, to enable the water tank to be self filling. The water tank is modified to provide a number of drainage holes at the full point on the tank, to prevent the tank from flooding. In a variation on this the control unit could be modified to switch on the pump when the water level in the tank raises above its full point, to pump the water out.

A suitable pump for use with the watering system is described in UK Patent Application GB 2 322 673 (Todd). This known pump operates by thermal expansion and contraction of a quantity of gas trapped in a housing. The expansion and contraction of the gas is used to pump water through the housing through to water the plant. The control unit activates the pump by switching on a heater which causes the gas to expand and for the water to be expelled out thought a non-return valve in the feed-pipe 12. This pump enables the pumping of liquids against the force of gravity without the use of mechanical diaphragms or pistons and is particularly suited for delivering small precise quantities of liquid, approximately 50 to 100 ml/hour and has low operational costs. Furthermore the pump housing can be constructed from plastics.

The watering was tested by an independent horticulturist Stockbridge Technology by potting single plants of Ficus into large clay pots containing 27 litres of a loam based compost. A thin layer of grit was placed on the compost surface. Three different watering systems were used:

1. An automatic watering system of the present invention which was placed in the base of each pot and water was added when the reservoir was low. The watering system was supplying water to the top surface of the soil beneath the layer of grit;

2. Water was manually applied overhead to stimulate normal practice, water added when the compost felt dry; and

3. Water was manually applied via a large saucer underneath the pot, water being added when the compost felt dry.

All plants were kept in a green house for 11 weeks with a minimum air temperature of 18° with ventilation at 21° C. The following results were then observed.

| | Automatic | Overhead | |
|---|---|---|---|
| | Watering | Watering | Base Watering |
| Total quality of | 9.75 litres | 11.5 litres | 22 litres |
| water used | | | |
| Number of new | 24 | 18 | 4 |
| leaves | | | |
| Height* | 69 cm | 61 cm | 59 cm |

*At the start of the trial all plants were between 52 to 54 cm tall.

At the end of the trial all plants were removed from their pots and their root structure examined. The roots of the plant fed by the automatic watering system were so well rooted into the compost they could not be removed. When the water was applied overhead root development was good, but for the base watered plant the roots had hardly started to move out of the original root ball.

### CONCLUSIONS

The automatic watering system encourages rapid development of new leaves, the plant was also more vigorous and larger in size, and the root development was also more extensive. Additionally the automatic watering system uses considerably less water enabling a particular application in areas having a water shortage and for the reduction of water bills for commercial outlets.

Water demands of a particular plant vary depending on the time of day, season, environment and growing/flowering cycles of the plant. The above described system is controlled by the needs of the plant. However, in a further embodiment the system is further modified in order to control the growing cycles of the plant and by this to optionally accelerate the growth, slow the growth or induce the plant to flower or fruit. In this embodiment the control unit is programmable to enable the watering of the plant in fixed amounts and cycles which are specifically adapted to that plant to provide control over the growth and life cycle of that plant.

A database of different plants is provided each having respective requirements for cycles of watering and amounts of watering to enable selective control of growth cycles for that plant. The database may be provided directly on the control unit with a selection means being provided to enable selection of the required programme, or the control unit may be Bluetooth™ or Wi-fi™ enabled to allow transfer of a selected program from the database to be loaded on to processing means of the control unit.

The database is constructed by measuring the requirements for individual plant species over a period of time and adjusting such for environment. One method of constructing such database is to form a control by taking 100 grams of potting compost and drying it out to zero moisture. Keep adding 10 ml of water until saturation is reached and measure the resistively. Repeat the process several times and plot the results to graph. This will give a value of ml of water per 100 grams of compost, for a particular sensor at a particular voltage. The procedure can be repeated for different compost to provide the settings for each plant type in a particular compost. Tests on the individual plants can then be conducted to provide the database of each plant species.

Although a specific sensor pulse rate and voltage has been described it is to be understood that such can also be adapted to suit a particular sensor and/or plant type. It has been found that the pulsed operation of the sensor has increased the plant vigour, with different pulse rates suitable for different plant types. The intermittent operation of the sensor, when compared to the continuous use of the prior sensor used in GB 2 322 673, has additionally prevented corrosion of the sensor. It was found that the prior sensor corroded after 6 months use, however the same sensor type (stainless steel) used with the present invention has shown no corrosion after 12 months use. The sensor once activated takes approximately 15 seconds to come into an operational state where it can take a reading, during its warm up there is an exponential rise of voltage, and once power is cut an exponential fall which results in a slight negative drop. It is this slight negative drop which inhibits ion migration and reduces sensor corrosion. The electrical current in the soil also stimulates plant growth, and is discussed further hereinunder.

As mentioned different pulse rates could be applied depending on the warm-up characteristics of the sensor used and the plant's requirements. Although a 5V voltage has been specifically described a different low voltage could be used, or the described pulsed dc voltage may be emulated by a low ac voltage. Low voltage ac voltage is less than 30 v whilst low voltage dc voltage is less than 50 v.

FIGS. 14 and 15 show the results of a trial to show plant growth stimulation when using a plant growth stimulator which generates an electromagnetic field through the soil. In this instance the field is provided by a low voltage electricity supply and this generated a field between two spaced apart electrodes buried in the soil. The electromagnetic stimulation was found to increase the rate of leaf, bud and flower generation.

As shown in FIG. 14 during a continuous trial of 40 days the number of leaves produced on Fuchsia plants were counted and plotted. The bottom line shows the plant of the control, where no electromagnetic stimulation is provided, and lines A, B and C respectively show the amount of leaf production for respective increases in the electromagnetic stimulation. The number of new buds produced by these plants during the trial are shown in FIG. 15. As can be seen both leaf, bud and flower (buds turning to flower) production increases as electromagnetic stimulation is increased.

The electromagnetic field can be generated by low voltage direct current and/or low voltage alternating current supplies and be applied continuously or intermittently (i.e. in a pulse-like manner).

The plant growth stimulator may comprise a control means which is used to adjust the electromagnetic field. The control may have a user interface for manual adjustment of a preset program and/or have means for accepting a program for its use which enables an electromagnetic field to be specifically tailored to the growth requirements of a specific plant or plants, and to stimulate selected growth cycles such as flowering, fruiting and growth.

The plant stimulator may be incorporated into the automatic watering system and share a common control. The electromagnetic field may be supplied through the moisture sensors of the watering system.

Although a sensor has been described for measuring the moisture content of the soil, and/or electrodes for supplying an electromagnetic field, the sensor could additionally, or additional sensor, could be provided to measure the temperature of the soil and a heater provided to adjust the temperature of the soil to an optimum condition for required growth stimulation of the plant based on said measurements. An atmospheric temperature sensor could be provided which measures the temperature of the surrounding air and provides control of a heater. A light sensor could be provided to provide data for the control of a UV or natural light source for the plant.

Nutrients may be provided in the water tank for delivery to the plant. A sensor may be provided in the water tank to monitor the level of nutrients and to provide an indication of when the nutrients need replenishing. A PH sensor may be provided in the soil to measure the acidity/alkalinity of the soil and to provide an indication of when the acidity needs adjustment to an optimum level for a particular plant type, by addition of appropriate soil conditioner.

The power unit may be mains or battery operated, or may be powered by a renewable energy source, e.g. solar power.

Although a voltage supply as been described as providing an electromagnetic field, such source may be magnetic or the field supplied could be a combination of electric, magnetic, ionic and static.

1-53. (canceled)

54. A method of watering a plant, comprising the steps of measuring a conductivity of a plant growing medium containing at least one plant, determining a moisture content of the growing medium from said measured conductivity, and supplying water to the plant if the determined moisture content is below a predetermined value, wherein the predetermined value is based on plant type, the step of measuring the conductivity is conducted using at least one sensor buried in the growing medium, and at least one sensor is intermittently powered.

55. The method according to claim 54, further comprising the step of stopping the supply of water once said predetermined level of moisture has been detected.

56. The method according to claim 54, further comprising the step of energizing the sensor for a period of time before determining said moisture content.

57. The method according to claim 54, further comprising the step of energizing the sensor for at least 15 seconds before determining said moisture content.

58. The method according to claim 54, wherein the sensor is energized for at least 60 seconds.

59. The method according to claim 54, further comprising the step of inducing plant growth by passing an electromagnetic field through the growth media of said at least one plant, in at least one of a continuous and intermittent (pulsed) manner.

60. The method according to claim 59, further comprising the step of adjusting said electromagnetic field to adapt it to do at least one of the following: stimulate at least one of induction of flowering, fruiting or growth of plant; to adapt it to the particular growth requirement of a specific plant type; and to adapt growth stimulation to at least one of season, time of day, growth media type, and growth medium condition.

61. The method according to claim 59, wherein the electromagnetic field is at least one of a low voltage AC or DC electrical current and magnetic field.

62. The method according to claim 54, further including the step of measuring the condition of the plant's environment and providing to the plant at least one of heat, moisture, plant nutrients and growth stimulation based on said detected condition.

63. The method according to claim 54, further comprising the step of measuring the condition of the growing medium to measure at least one of moisture content of the growing medium, PH of the growing medium, temperature of the growing medium or environment.

64. The method according to claim 54, wherein operation of the sensor is governed by the equation KX=Y−π, in which
X=Applied voltage
Y=Actual sensor voltage reading, and
K=A growing medium constant for a particular growing medium.

65. The method according to claim 54, wherein moisture content is determined for a particular plant growing medium by applying a third order polynomial Y=ax³+bx²+cx+d, wherein
Y=Actual sensor voltage, and
X=Applied voltage.

66. A system for carrying out the method of watering a plant with a closed loop moisture control system, comprising a plant, a water supply system for supplying water to the plant, a moisture sensor located in the root region of the plant for measuring the level of moisture in the growing medium of the plant, a control unit with means to switch the watering system off or on based on said detected moisture level, means for energizing the sensor, and means to compare the detected moisture level with a predetermined value.

67. The system as claimed in claim 66, wherein the moisture sensor comprises at least one pair of spaced apart electrodes and the sensor is energized by applying an adjustable preset voltage to the electrodes in order to measure the conductivity of the growing medium between the electrodes, the control unit having means to determine the level of moisture in the growing medium based on said measured conductivity, wherein said electrodes have at least one of the following properties: are spaced between 40 to 100 mm apart; have a surface area of between 400 mm and 1000 mm; have a length of 80 to 20 mm each; and a width of 2 to 4 mm each.

68. The system as claimed in claim 66, wherein said control unit has means to set a predetermined voltage, said predetermined voltage being a function of at least one of plant type, growing medium type, and sensor type.

69. The system according to claim 66, wherein the water supply system comprises a water tank with at least one soaker pipe leading therefrom, the soaker pipe being adapted to supply water to said plant, and wherein the water supply system includes a pump to pump water from the tank to the soaker pipe, the pump being switched on and off by said means for switching the watering system on or off.

70. A system according to claim 69, wherein the pump is operated by pumping water using thermal expansion and contraction of a quantity of gas trapped in a housing.
